(19) United States
(12) Patent Application Publication
(10) Pub. No.: US 2017/0186070 A1
(43) Pub. Date: Jun. 29, 2017

(54) METHOD, SYSTEM, AND DEVICE FOR PROVIDING ITEM INFORMATION

(71) Applicant: Alibaba Group Holding Limited, Grand Cayman (KY)

(72) Inventor: Qi Dong, Hangzhou (CN)

(21) Appl. No.: 15/384,111

(22) Filed: Dec. 19, 2016

(30) Foreign Application Priority Data
Dec. 23, 2015 (CN) 201510983047.9

(51) Int. Cl. G06Q 30/06; H04L 29/06; G06T 11/00; G06F 17/22; G06F 17/21; H04L 29/08; G06F 17/30

(52) U.S. Cl. CPC G06Q 30/0631; H04L 67/02; H04L 67/42; G06F 17/30864; G06F 17/30905; G06F 17/2247; G06F 17/212; G06T 11/001; G06F 17/2211

(57) ABSTRACT

A method for providing item information is disclosed. The method may comprise receiving, by a server, a webpage access request, and providing, by the server, a target webpage based on the received webpage access request. The target webpage may comprise a target information presentation position presenting information about at least two items in the same item group, and the item group may comprise at least two similar items that differ in an attribute value of a predetermined dimension.

### CROSS REFERENCE TO RELATED APPLICATION

The present application is based on and claims the benefit of priority to Chinese Application No. 201510983047.9, filed Dec. 23, 2015, the entire contents of which are incorporated herein by reference.

### TECHNICAL FIELD

The present disclosure relates generally to computer technologies, and more particularly, to methods, systems, and devices for providing item information.

### BACKGROUND

In e-commerce transaction platforms, various item information is usually on web webpages. Such information generally includes various types of webpage elements, such as pictures, audio, video, or text. From the pictures, consumers can learn the color, shape, style, and other visual attributes of items. If some items, such as musical instruments, have an auditory attribute, an audio or video may also be embedded into the webpage to exhibit the auditory attribute to consumers. Attributes of other aspects and more detailed information can be described using text information, which can, for example, enable consumers to learn the sizes, the materials, and the modes of use. Thus, the item information presented in web webpages can enable consumers to develop an understanding of the items and help them make purchase decisions.

As the number of users continuously increases, various e-commerce transaction platforms have developed their own featured channels. For example, Alibaba's Tmall platform has developed Tmall Global and Tmall Supermarket channels. The “Supermarket” channel mainly sells necessities and food groceries, which are common items in brick and mortar supermarkets. The “Supermarket” channel allows consumers to have the experience of shopping in a supermarket online, and therefore is a great attraction for consumers.

In addition to providing more categories and brands of items, developers and designers also need to constantly improve the webpage presentation effect to simulate the real supermarket environment, so that online shoppers would feel like shopping in a real supermarket. To this end, it is also important to improve the effective utilization of the item information.

### SUMMARY

One aspect of the present disclosure is directed to a method for providing item information. The method may comprise receiving, by a server, a webpage access request, and providing, by the server, a target webpage based on the received webpage access request. The target webpage may comprise a target information presentation position presenting information about at least two items in the same item group, and the item group may comprise at least two similar items that differ in an attribute value of a predetermined dimension.

Another aspect of the present disclosure is directed to a method for providing item information. The method may comprise sending, by a client, a webpage access request to a server, receiving webpage data from the server, and presenting a target webpage based on the received webpage data. The target webpage may comprise a target information presentation position presenting information about at least two items in the same item group, and at least two items in the item group may differ in an attribute value of a predetermined dimension.

Another aspect of the present disclosure is directed to a method for establishing an item information database. The method may comprise publishing goods having different attribute values in a predetermined dimension as different front-end items, and determining, from the items, item groups each comprising at least two items that satisfy a predetermined condition, wherein the at least two items in the same item group differ in the attribute value of the predetermined dimension, and storing identification information of the items in each item group to generate an item information database, causing the items in the same item group to be presented in the same information presentation position, when an item information list is presented in a webpage.

Another aspect of the present disclosure is directed to a webpage for presenting item information. The webpage may comprise a target information presentation position presenting information about at least two items in the same item group. The item group may comprise at least two similar items that differ in an attribute value of a predetermined dimension.

Another aspect of the present disclosure is directed to an apparatus for providing item information. The apparatus may comprise a request receiving unit configured to receive a webpage access request, and a webpage data providing unit configured to provide a target webpage based on the webpage access request, wherein the target webpage comprises a target information presentation position presenting information about at least two items in the same item group, and the item group comprises at least two similar items that differ in an attribute value of a predetermined dimension.

Another aspect of the present disclosure is directed to an apparatus for providing item information. The apparatus may comprise a request forwarding unit configured to send a webpage access request to a server, a webpage data receiving unit configured to receive webpage data from the server, and present a target webpage based on the received webpage data. The target webpage may comprise a target information presentation position presenting information about at least two items in the same item group, and at least two items in the item group may differ in an attribute value of a predetermined dimension.

Another aspect of the present disclosure is directed to an apparatus for establishing an item information database. The apparatus may comprise an item publishing unit configured to publish goods having different attribute values in a predetermined dimension as different front-end items, an item group determining unit configured to determine, from the items, item groups each comprising at least two items that satisfy a predetermined condition, wherein the at least two items in the same item group differ in the attribute value of the predetermined dimension, and an information storage unit configured to store identification information of the items in each item group to generate an item information database, causing the items in the same item group to be presented in the same information presentation position, when an item information list is presented in a webpage.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a flowchart illustrating a first method for providing item information, consistent with exemplary embodiments of the present disclosure.

FIG. 2 is a schematic diagram illustrating a webpage for providing item information, consistent with exemplary embodiments of the present disclosure.

FIG. 3 is a flowchart illustrating a second method for providing item information, consistent with exemplary embodiments of the present disclosure.

FIG. 4 is a flowchart illustrating a third method for providing item information, consistent with exemplary embodiments of the present disclosure.

FIG. 5 is a schematic diagram illustrating a first system for providing item information, consistent with exemplary embodiments of the present disclosure.

FIG. 6 is a schematic diagram illustrating a second system for providing item information, consistent with exemplary embodiments of the present disclosure.

FIG. 7 is a schematic diagram illustrating a third system for providing item information, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

In practical applications, some goods may have the following characteristics: the same series of products of the same brand may have various attribute values in dimensions such as color, pattern, package volume, unit, flavor, aroma, etc. A dimension can mean an aspect, feature, characteristic, etc. For example, a certain collection of potato chips of a brand includes different flavors such as original, spicy, and tomato; a collection of laundry detergents of a brand includes different scents such as lavender and vanilla; facial tissues of a brand includes different package sizes such as small individual packs, 12 packs, and 24 packs.

In existing technologies, to express the association among goods or items of the same collection but differ in some attribute value, these goods or items are usually combined and categorized as the same item. That is to say, various items having different attribute values are expressed as one item in an item list webpage. Consumers need to select an item from the list, enter a details webpage of the item in order to view options related to various specific attributes such as the specification parameter of the item, and then determine, by selection or otherwise, a stock keeping unit (SKU) they actually need to buy. The webpage in this disclosure may be presented by a program, an application, or the like of a terminal device such as a computer or a mobile phone.

Although this method can save system resources to some extent, it is not intuitive enough for consumers. Especially for webpages like “Tmall Supermarket”, this method cannot reflect the richness of goods, and fails to simulate the real shopping experience in supermarkets. In contrast, in an offline brick and mortar supermarket, the same series of goods of different flavors, scents, and specifications may be placed side by side on shelves. This allows shoppers to learn various specific attribute values of the items in a glance, making it more convenient for them to purchase necessities and food groceries. In view of this, in the embodiments of the present disclosure, the expression and the presentation of items in list webpages are improved, to simulate an experience closer to shopping in a physical supermarket, and to improve the effective utilization of item information.

In some embodiments, first, goods having different attribute values in a predetermined dimension may be published as different front-end items. The predetermined dimension may mainly include a perceptual attribute dimension other than a color attribute, a package volume dimension, or the like. For example, if a collection of potato chips of a brand includes three different flavors: original, spicy, and tomato, they may be published as three independent items. When these items are presented in a webpage, a special information presentation area (or position) may be determined in advance, may be in the shape of a cross bar or the like, and may have a size larger than that of a common information presentation area (or position) presenting summary information of an item. Items of the same collection of the same brand but differ in the attribute value of a predetermined dimension can be presented in the special information presentation area (or position).

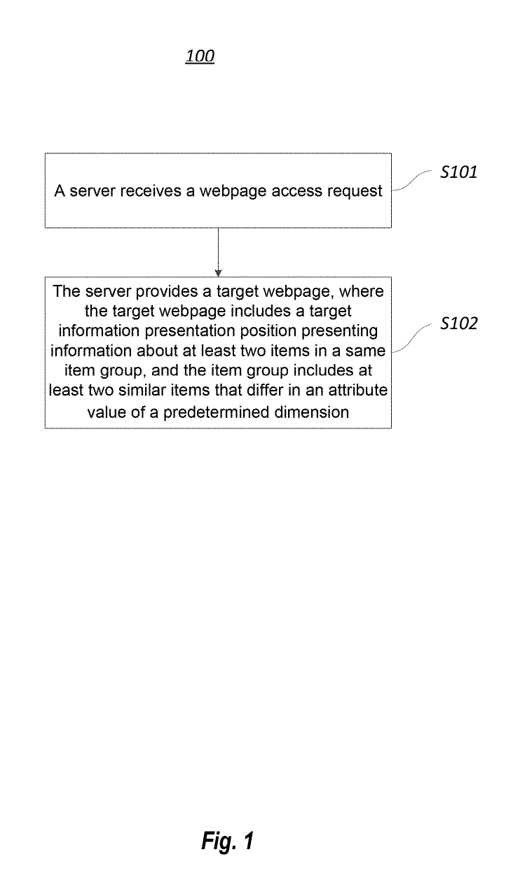

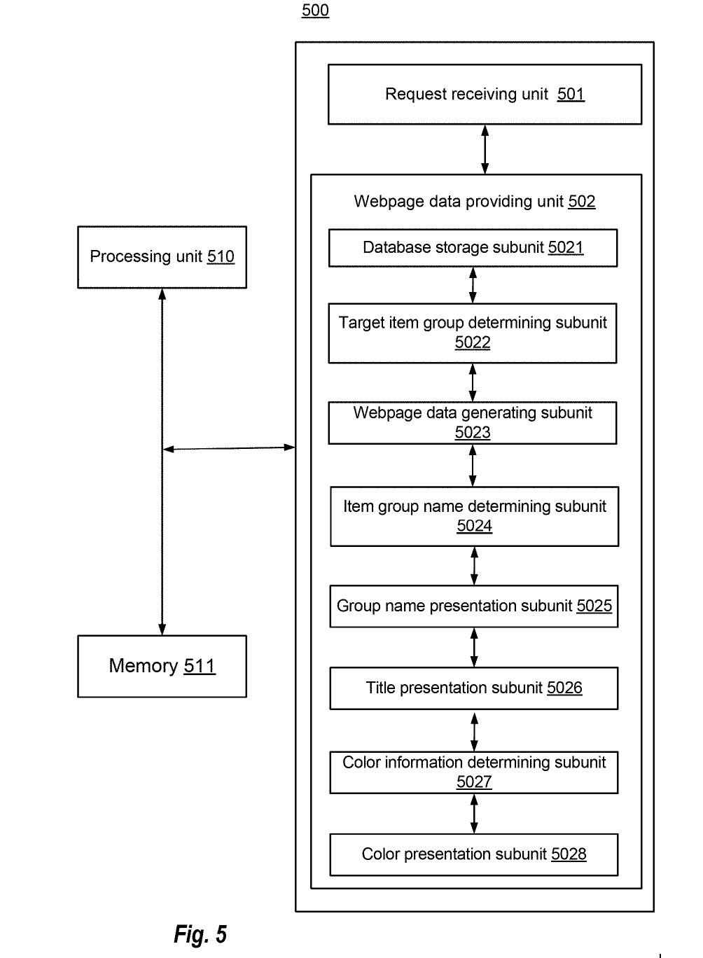

In some embodiments, a method for providing item information is disclosed. The method may be implemented by a specialized server, e.g., system 500 described below with reference to FIG. 5. FIG. 1 is a flow diagram illustrating a method 100 for providing item information, consistent with exemplary embodiments of the present disclosure. Method 100 may include the following steps, some of which may be optional.

S101: A server may receive a webpage access request.

S102: The server may provide a target webpage based on the received webpage access request, where the target webpage includes a target information presentation position presenting information about at least two items in the same item group, and the item group includes at least two similar items that differ in an attribute value of a predetermined dimension. The target webpage may include an item list webpage, for example, the “Imported Products” of “Tmall Supermarket.”

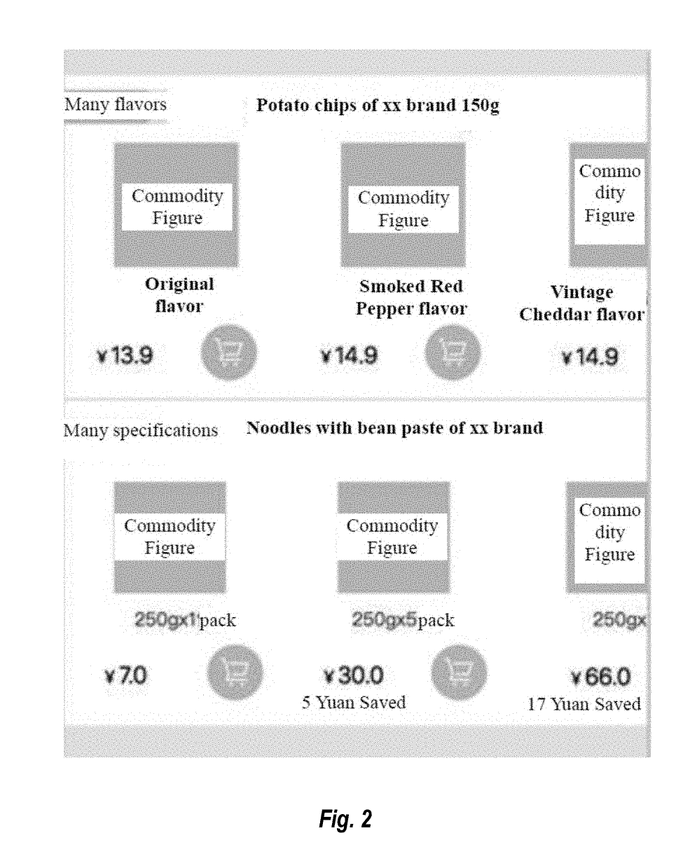

The term “similar items” may refer to items that belong to the same collection (or type, genre, classification, class, and etc.) as the current item but differ from the current item in a perceptual attribute value, e.g., potato chips of the same collection but having different flavors. Alternatively, the term “similar items” may refer to items that belong to the same category as the current item but differ from the current item in the perceptual attribute value, and so on. For example, FIG. 2 shows two information presentation positions in a webpage, in which potato chips of the same collection but different flavors are presented in one presentation position, and facial tissues of the same brand but different package volumes are presented in the other presentation position.

The information presentation position may be an area such as a bar-shaped area, and may include a plurality of information presentation sub-positions, each of which presenting summary information of one item in the group. If an item group includes a large number of items, and when the items are presented in the same information presentation position, some items may fail to appear in the current screen. Therefore, the information presentation position may further be designed to receive a slide operation. In this way, in an initial state, some items in the item group can be presented; then, after a slide operation, more items in the group can be presented in the information presentation position.

In one embodiment, the above-mentioned special information presentation position in the webpage may be designed in advance in the webpage building process. Specific items to be presented in the information presentation position may be determined in various manners, for example, may be manually set by a webpage designer or may be dynamically determined by a server. There are multiple methods for dynamically determining the specific items to be presented. For example, in one method, the step S102 may include the following sub-steps:

Step 1: Create and use an item information database to store at least one item group, the item group including at least two items that differ only in the attribute value of the predetermined dimension.

There may be multiple methods for creating the database. For example, the database is created manually, or the database is automatically created by a server. Examples of automatically creating the database are discussed below with reference to embodiments described after step S302.

Step 2: Determine, upon receiving the request for presenting the webpage (e.g., the target webpage), a target item group associated with the target information presentation position in the target webpage.

If webpage data of the target webpage has been edited in advance, the server can directly return the edited webpage data. However, in practical applications, to realize dynamic updating of webpage contents, a specific information presentation position in the target webpage may be associated with a rule for selecting a target item group. In this way, the server can select a target item group according to the rule, without requiring a designer to manually set a target item group. Also, there may be multiple selection rules. For example, the information presentation position may be associated with an item group with the highest sales volume under a category, or may be associated with an item group that participates in a promotion activity under a particular category. Information such as sales volume data and activity participation status can be obtained by querying other related databases.

Step 3: Generate webpage data of the target webpage according to information of items in the target item group.

After determining an item group associated with the target information presentation position and determining items included in the item group according to the item information database, the server can generate the webpage data and return the webpage data to a client.

In some embodiments, the item information database may further store a name of the item group and a target text describing the attribute value of the predetermined dimension in a title of each item, the name of the item group being determined according to an identical part of the titles of all the items in the group. The target information presentation position may include an information presentation bar for presenting the name of the item group and a plurality of information presentation sub-positions. In this case, the server may further determine the name of the target item group and the target texts corresponding to the items according to the item information database. In this way, the name of the item group can be presented in the information presentation position, and when representative pictures and titles of items in the item group are presented in the information presentation sub-positions, only the target texts may be presented as the titles.

The predetermined dimension may include a perceptual attribute dimension other than a color attribute or a package volume dimension. When the predetermined dimension is a perceptual attribute dimension other than the color attribute, the item information database may further store a correspondence among an identifier, the target text, and a target color of the item in the item group, the target text describing the perceptual attribute value other than the color attribute of the target in the title of the item, and the target color expressing the perceptual attribute value other than the color attribute of the target. In this case, the server may further determine the target text and the target color that correspond to each item in the target item group, so that when presenting the items in the same item group, the client presents, in different target colors, the target texts corresponding to the items of the perceptual attribute value(s) other than the color attribute of different targets.

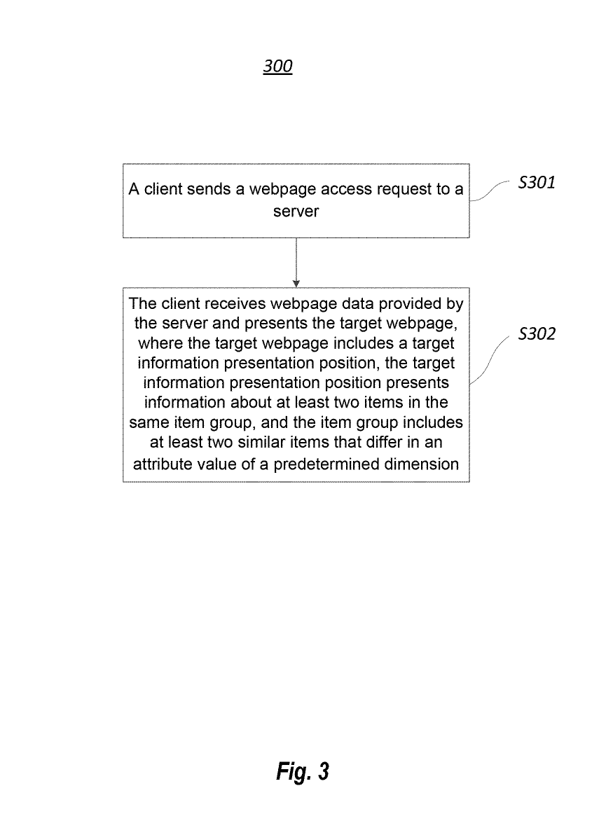

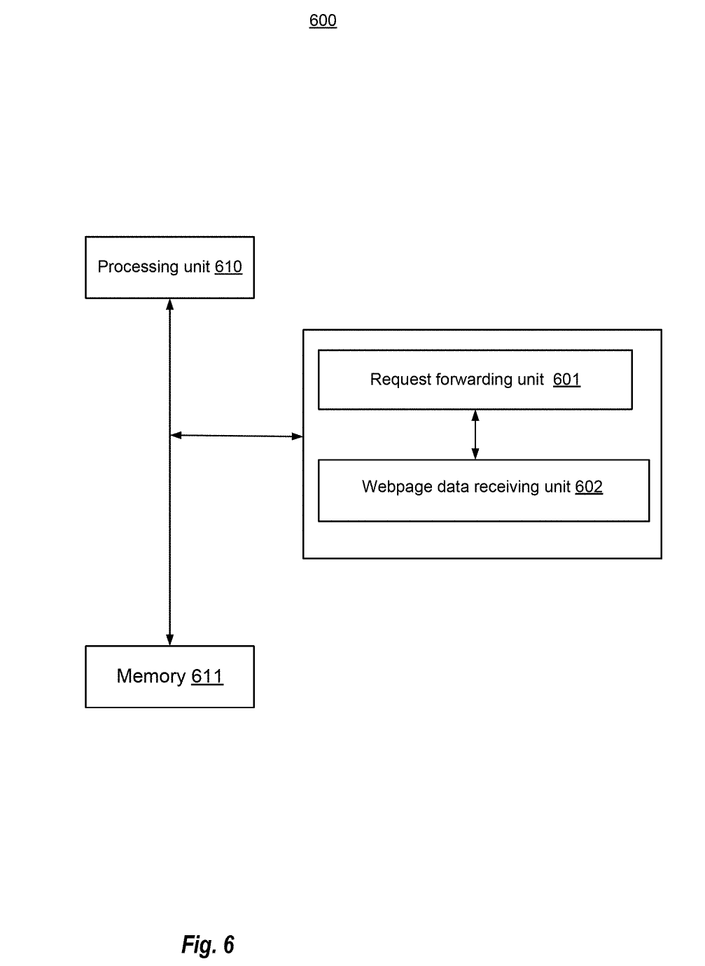

In some embodiments, a method for providing item information is disclosed. The method may be implemented by a client, e.g., a client terminal device, an system 600 described below with reference to FIG. 6. FIG. 3 is a flow diagram illustrating a method 300 for providing item information, consistent with exemplary embodiments of the present disclosure. Method 300 may include the following steps, some of which may be optional.

S301: A client sends a webpage access request to a server.

S302: The client receives webpage data provided by the server and presents the target webpage based on the received webpage data, where the target webpage includes a target information presentation position, the target information presentation position presents information about at least two items in the same item group, and the item group includes at least two similar items that differ in an attribute value of a predetermined dimension.

In one embodiment, an item information database may be stored in the server in advance, where the database stores at least one item group, the item group includes at least two items that satisfy a predetermined condition, and the at least two items differ only in the attribute value of the predetermined dimension. After receiving the request, the server may first determine a target item group associated with the target information presentation position in the target webpage, and then generate webpage data of the target webpage according to information about items included in the target item group, and return the webpage data.

Method 300 can be referenced with method 100 described above, and the details are not repeated here.

There may also be multiple methods for creating the foregoing item information database. For example, the item information database may be created manually for a small number of items. However, for a large number of items, the manual creation method may be inefficient and may require a large amount of manpower and time. In view of this, the embodiments of the present disclosure also provide an implementation manner in which the server automatically creates the item information database. The method for creating the database is described below.

A method for establishing an item information database is disclosed. In the method, goods having different attribute values in a predetermined dimension may be published as different items at the website front-end. The predetermined dimension may include a perceptual attribute dimension other than a color attribute or a package volume dimension. As described in the examples above, if a collection of potato chips of a brand includes three different flavors: original, spicy, and tomato, they may be published as three independent items. For another example, if a collection of instant noodles of a brand includes three different package volumes in the package volume dimension: small individual packs, 5-packs, and 12-packs, they may also be published as three independent items.

When the items are published, a title, representative picture, detailed information, and the like may be configured for each item. Since the independent items differ only in the attribute value of the predetermined dimension and are the same in other attributes, description information of the attribute value of the predetermined dimension may be added to the title for each item, so that a user can distinguish the attribute values of the items according to the titles of the items. In addition to the foregoing attribute value, the title may further include other information, such as the place of origin, name of the item, specification, and the like. For the original-flavor potato chips in the foregoing example, the title may be “handmade potato chips of xx brand 150 g original flavor.” In addition, the collection of potato chips may also include a smoked red pepper flavor. In this case, the title of another published item may be “handmade potato chips of xx brand 150 g smoked red pepper flavor.” For instant noodles in small individual packages in the foregoing example, the title may be “noodles with bean paste of xx brand 250 g×1 pack,” and for instant noodles in 5-packs, the corresponding title may be “noodles with bean paste of xx brand 250 g×5 packs.”

As described above, the titles of the items may differ only in the description information of the attribute value of the predetermined dimension, with the rest being the same. In addition, a text used by the user to describe the attribute value in the title can be spaced apart from other text contents by a separator such as a space. In this way, items grouped into the same group can be conveniently identified according to titles of different items. Therefore, in the process of configuring titles, people in charge of configuration may be required to perform configuration according to the above rule.

When the items are published, corresponding representative pictures may also be respectively configured for the items having different attribute values. The representative pictures can present the packaging of goods. When various goods having different attribute values are produced by a manufacturer, there may be some correlation in the design of the packaging. For example, packages of potato chips of various flavors in the foregoing example are primarily in gray color, and the difference between different flavors is reflected by the color of a small area on the package. Therefore, the representative pictures of the items may be associated with each other in terms of pixel features.

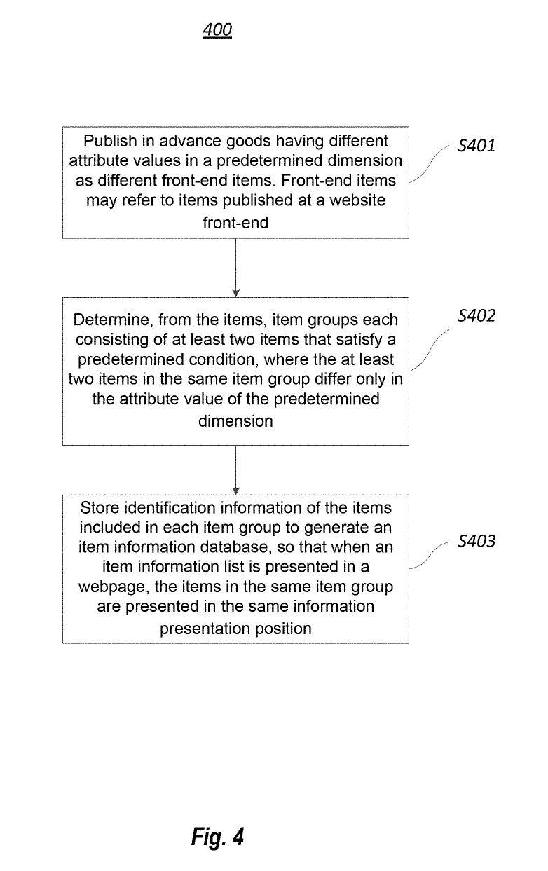

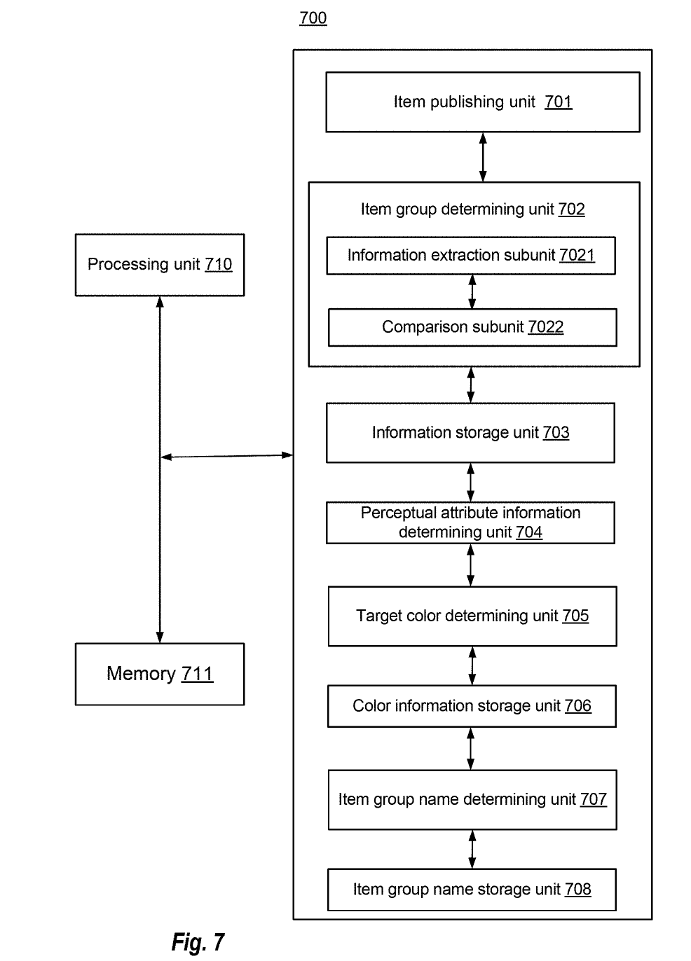

On this basis, in some embodiments, a method for providing item information is disclosed. The method may be implemented by a client or a server, e.g., system 700 described below with reference to FIG. 7. FIG. 4 is a flow diagram illustrating a method 400 for providing item information, consistent with exemplary embodiments of the present disclosure. Method 400 may include the following steps, some of which may be optional.

S401: Publish in advance goods having different attribute values in a predetermined dimension as different front-end items. Front-end items may refer to items published at a website front-end.

S402: Determine, from the items, item groups each consisting of at least two items that satisfy a predetermined condition, where the at least two items in the same item group differ only in the attribute value of the predetermined dimension.

When goods having different attribute values in the predetermined dimension are published as different items, item groups each consisting of at least two items can be determined in the items. For example, at least two items that differ only in the attribute value of the predetermined dimension can be grouped in an item group. In this way, the target information presentation position in the webpage can be associated with the item group, and the items in the item group can be presented in the same information presentation position.

There may be multiple methods for determining the item group. For example, in one method, an operation such as semantic analysis may be performed on the detailed information of the published items to determine items that differ only in the attribute value of the predetermined dimension, and have the same other attributes. Alternatively, as described above, the titles of the items may be set according to a predetermined rule. In this way, first, attribute value information of each item in the predetermined dimension can be extracted from the titles of the items; then, the remaining parts of the titles other than the attribute value information in the predetermined dimension can be compared, and at least two items having the same remaining parts can be determined as satisfying the predetermined condition.

There may be multiple methods for extracting the attribute value information in the predetermined dimension from the titles. For example, if the titles are stored in the form of a character string, a predetermined keyword may be first used to make a determination. For example, because the predetermined dimension may be a perceptual attribute dimension other than a color attribute or may be a package volume dimension, the predetermined keyword can be used to describe a specific attribute value in the title. For example, the perceptual attribute value other than the color attribute may be expressed as “xx flavor,” and the attribute value of the package volume dimension may be expressed as “xx packs,” “xx g,” or the like. Therefore, “flavor,” “pack,” “g,” and the like may be used as the keywords. If the title of an item contains these keywords, it may indicate that the title may carry the attribute in the predetermined dimension. Then, a specific attribute value may be extracted from characters before the keyword in the title. For example, if a text for describing the attribute value in a configured title is spaced apart from other contents in the title by a separator such as space, a search can be performed starting from the keyword towards the beginning of the title, until a separator appears, where the part between the separator and the keyword (including the keyword) can be determined as the target text expressing the specific attribute value in the predetermined dimension. If the remaining texts obtained by moving the target texts from the titles are the same, the corresponding items can be grouped into the same item group.

If the titles are stored using attribute editing results in a plurality of annotation fields, the server may directly query for an attribute dimension corresponding to each annotation field, extract an attribute value of a target dimension, determine content in other annotation fields as the title content other than the attribute value, and then perform comparison between the items. Thereby, the processing efficiency can be improved.

S403: Store identification information of the items included in each item group to generate an item information database, so that when an item information list is presented in a webpage, the items in the same item group are presented in the same information presentation position.

After at least one item group is determined, identification information of items included in each item group may be stored. For example, the stored content may be as shown in Table 1 below:

TABLE 1

| Number of item group | Identifier of item |
|---|---|
| item group 1 | item 1, item 2 . . . |
| item group 2 | item 3, item 4 . . . |
| . . . | . . . |

In this way, when an item information list is presented in a webpage, the items in the same item group can presented in the same information presentation position.

For the same item group, an identical part of the titles of the items in the group may be extracted to serve as a name of the item group, and stored in the item information database. In addition, the target text expressing the attribute value in the predetermined dimension in the title of each item may also be stored in the database. In this way, when the items in the group are presented in the information presentation position, the name of the item group may be presented in the first line. Then, when the titles of the items are presented, only the target texts expressing the attribute value of the target dimension may be presented. For example, in FIG. 2, the name of the item group presented in the first information presentation position is “potato chips of xx brand 150 g,” and when the titles of the items are presented in the information presentation positions, only the target texts “original flavor” and “smoked red pepper flavor” are presented. In this case, the content stored in the item information database may be as shown in Table 2 below:

TABLE 2

| Number of | Name of | Identifier and target text of |
|---|---|---|
| item group | item group | item |
| item group 1 | potato chips of | (item 1, original flavor), (item |
| | xx brand | 2, smoked red pepper flavor) . . . |
| item group 2 | noodles with bean | (item 3, 250 g × 1 pack), (item 4, |
| | paste of xx brand | 250 g × 5 packs) . . . |
| . . . | . . . | |

In addition, for an item group that has a perceptual attribute other than the color attribute, usually a particular flavor, scent, or the like can be used in the title of each item to express the attribute value of the dimension. In the embodiments of the present disclosure, to enable the presented information to express the perceptual attribute other than the color attribute more intuitively, the target text expressing the specific perceptual attribute value other than the color attribute may further be presented in a target color, where the target color corresponds to the specific perceptual attribute value other than the color attribute. For example, for smoked red pepper-flavor potato chips, the target text “smoked red pepper flavor” may be presented in red and the target text in this example does not express a color attribute of the item.

Accordingly, when the item information database is created, a correspondence among the identifier, the target text, and the target color of the item may further be stored in the item information database, the target text expressing the perceptual attribute value other than the color attribute in the title, and the target color expressing the perceptual attribute value other than the color attribute. There may be multiple methods for determining the target color. For example, various possible correspondences between the perceptual attribute value other than the color attribute and predetermined colors may be stored in advance. To determine a target color for a target text of an item, first, the perceptual attribute value other than the color attribute of the target can be extracted from description information in the title of the item, and then the corresponding target color can be determined by querying the correspondences. Alternatively, since the representative picture of the item may be a picture of the packaging of the item, and the color of the packaging may be related to the perceptual attribute value other than the color attribute, the target color can be extracted from the representative picture of the item. There may be other implementation manners, which will not be enumerated herein. As described above, the information stored in the item the database may be as shown in Table 3 below:

TABLE 3

| Number of | Name of | Identifier and target text of |
|---|---|---|
| item group | item group | item |
| item group 1 | potato chips of | (item 1, original flavor, (R1, |
| | xx brand | G1, B1)), (the item 2, |
| | | smoked red pepper flavor, |
| | | (R2, G2, B2)) . . . |
| item group 2 | noodles with bean | (item 3, 250 g × 1 pack, (R3, |
| | paste of xx brand | G3, B3)), (item 4, 250 g × 5 |
| | | packs, (R4, G4, B4)) . . . |
| . . . | . . . | . . . |

R, G, and B represent the values of red, green, and blue color components, respectively.

Once the item information database has been created, the database can be used to provide webpage data. In one example, an association relationship between the information presentation position and the item group may be established by a webpage designer, and after receiving a request for presenting a target webpage, the server can directly return the designed webpage data to the client. Alternatively, the server can dynamically generate webpage data and then return the webpage data to the client.

A webpage for presenting item information is also disclosed. The webpage may include a target information presentation position, where the target information presentation position presents information about at least two items in the same item group, and the item group includes at least two similar items that differ in an attribute value of a predetermined dimension.

The target information presentation position may include an information presentation bar presenting a name of the item group and a plurality of information presentation sub-positions, the name of the item group being determined according to an identical part in titles of all the items in the item group. Contents presented in the information presentation sub-positions may include a target text that corresponds to each item and describes the attribute value of the predetermined dimension.

The predetermined dimension may include a perceptual attribute dimension other than a color attribute. When information about the at least two items in the item group is presented, the target text describing the attribute value of the predetermined dimension in the title of each item is presented in a predetermined target color, the target color expressing the perceptual attribute value other than the color attribute of the target.

In summary, through the embodiments of the present application, goods having different attribute values in a predetermined dimension can be published as different items. Items that differ only in the attribute value of the predetermined dimension but similar in other attributes can be grouped in an item group, and items in the same item group can be presented in the same information presentation position. This presentation method can reflect the richness of attribute values of goods more intuitively, and can be more similar to the presentation mode of goods in a physical supermarket. This method can provide users an experience closer to shopping in a physical supermarket, promote purchase activities, and improve the effective utilization of information presented in webpages.

Correspondingly, an apparatus for providing item information is disclosed. The apparatus may be a server publishing goods having different attribute values in a predetermined dimension as different front-end items. FIG. 5 is a block diagram illustrating an system 500 for providing item information, consistent with exemplary embodiments of the present disclosure. System 500 may include the following components, some of which may be optional. The components in FIG. 5 may be arranged in another order. System 500 may include, for example, a processing unit 510 and a memory 511. Memory 511 may be a non-transitory computer-readable storage medium storing instructions that, when executed by processing unit 510, cause one or more components of system 500 to perform the steps and methods described in this disclosure. System 500 may include functional modules implemented by the processing unit 510 and the memory 511, including, e.g., a request receiving unit 501 and a webpage data providing unit 502. The request receiving unit 501 and the webpage data providing unit 502 refer to or correspond to blocks of software code stored on memory 511. The processing unit 506 can execute the blocks of software code and perform the functions corresponding to the functional modules.

The request receiving unit 501 may be configured to receive a request for presenting a target webpage.

The webpage data providing unit 502 may be configured to provide a target webpage, where the target webpage includes a target information presentation position presenting information about at least two items in the same item group, and the item group includes at least two similar items that differ in an attribute value of a predetermined dimension.

In some embodiments, the webpage data providing unit 502 may include:

a database storage subunit 5021, configured to create and use item information database to store at least one item group, the item group including at least two items that differ only in the attribute value of the predetermined dimension;

a target item group determining subunit 5022, configured to determine, upon receiving the request for presenting a target webpage, a target item group associated with the target information presentation position in the target webpage; and

a webpage data generating subunit 5023, configured to generate webpage data of the target webpage according to information about items included in the target item group.

The item information database may further store a name of the item group and a target text describing the attribute value of the predetermined dimension in a title of each item, the name of the item group being determined according to an identical part in the titles of all the items in the group. The target information presentation position may include a name presentation bar and a plurality of information presentation sub-positions.

The webpage data providing unit 502 may further include:

an item group name determining subunit 5024, configured to determine the name of the target item group and the target text that corresponds to each item;

a group name presentation subunit 5025, configured to present the name of the target item group in the information presentation bar of the target information presentation position; and

a title presentation subunit 5026, configured to present, in the information presentation sub-positions, representative pictures and titles of the items in the group, where the title includes only the target text.

The predetermined dimension may include a perceptual attribute dimension other than a color attribute, and the item information database may further store a corresponding relationship among an identifier, a text, and a color of each item in the item group, the text describing the perceptual attribute value in the title of the item, and the color expressing the perceptual attribute value.

The webpage data providing unit 502 may further include:

a color information determining subunit 5027, configured to determine a target text and a target color that correspond to each item in the target item group; and

a color presentation subunit 5028, configured to, in the information presentation sub-positions, present the target texts, of the items in the group, in the corresponding target colors.

The predetermined dimension may include a package volume dimension.

Correspondingly, an apparatus for providing item information is disclosed. The apparatus may be a client. FIG. 6 is a block diagram illustrating an system 600 for providing item information, consistent with exemplary embodiments of the present disclosure. System 600 may include the following components, some of which may be optional. The components in FIG. 6 may be arranged in another order. System 600 may include, for example, a processing unit 610 and a memory 611. Memory 611 may be a non-transitory computer-readable storage medium storing instructions that, when executed by processing unit 610, cause one or more components of system 600 to perform the steps and methods described in this disclosure. System 600 may include functional modules implemented by the processing unit 610 and the memory 611, including, e.g., a request forwarding unit 601 and a webpage data receiving unit 602. The request forwarding unit 601 and the webpage data receiving unit 602 refer to or correspond to blocks of software code stored on memory 611. The processing unit 610 can execute the blocks of software code and perform the functions corresponding to the functional modules.

The request forwarding unit 601 may be configured to send a webpage access request to a server.

The webpage data receiving unit 602 may be configured to receive webpage data provided by the server and present the target webpage, where the target webpage includes a target information presentation position, the target information presentation presents information about at least two items in the same item group, and the item group includes at least two similar items that differ in an attribute value of a predetermined dimension.

In one embodiment, an item information database may be stored in the server in advance, where the database stores at least one item group, the item group includes at least two items that satisfy a predetermined condition, and the at least two items differ only in the attribute value of the predetermined dimension. After receiving the request, the server may determine a target item group associated with the target information presentation position in the target webpage, generate webpage data of the target webpage according to information about items included in the target item group, and return the webpage data.

Correspondingly, an apparatus for establishing an item information database, where goods having different attribute values in a predetermined dimension may be published as different front-end items, is disclosed. FIG. 7 is a block diagram illustrating an system 700 for providing item information, consistent with exemplary embodiments of the present disclosure. System 700 may include the following components, some of which may be optional. The components in FIG. 7 may be arranged in another order. System 700 may include, for example, a processing unit 710 and a memory 711. Memory 711 may be a non-transitory computer-readable storage medium storing instructions that, when executed by processing unit 710, cause one or more components of system 700 to perform the steps and methods described in this disclosure. System 700 may include functional modules implemented by the processing unit 710 and the memory 711, including, e.g., an item publishing unit 701, an item group determining unit 702, an information storage unit 703, a perceptual attribute information determining unit 704, a target color determining unit 705, a color information storage unit 706, an item group name determining unit 707, and an item group name storage unit 708. The item publishing unit 701, the item group determining unit 702, the information storage unit 703, the perceptual attribute information determining unit 704, the target color determining unit 705, the color information storage unit 706, the item group name determining unit 707, and the item group name storage unit 708 refer to or correspond to blocks of software code stored on memory 711. The processing unit 710 can execute the blocks of software code and perform the functions corresponding to the functional modules.

The item publishing unit 701 may be configured to publish in advance goods having different attribute values in a predetermined dimension as different front-end items.

The item group determining unit 702 may be configured to determine, from the items, item groups each comprising at least two items that satisfy a predetermined condition, where the at least two items in the same item group differ only in the attribute value of the predetermined dimension.

The information storage unit 703 may be configured to store identification information of the items included in each item group to generate an item information database, so that when an item information list is presented in a webpage, the items in the same item group are presented in the same information presentation position.

The predetermined dimension may include a perceptual attribute dimension other than a color attribute.

In this case, the system 700 may further include:

a perceptual attribute information determining unit 704, configured to determine a perceptual attribute value of an item, and a target text describing the perceptual attribute value in a title of the item;

a target color determining unit 705, configured to determine a target color that corresponds to the perceptual attribute value other than the color attribute of the target; and

a color information storage unit 706, configured to store, in the item information database, a correspondence between an identifier, the target text and the target color of the item, so that when the items in the same item group are presented, the target texts corresponding to the items of the perceptual attribute value other than the color attribute of different targets are presented in different target colors.

In addition, the predetermined dimension may further include a package volume dimension.

The item group determining unit 702 may include:

an information extraction subunit 7021, configured to extract, from the titles of the items, attribute value information of each item in the predetermined dimension; and

a comparison subunit 7022, configured to compare the remaining parts of the titles other than the attribute value information in the predetermined dimension, and determine at least two items having the same remaining parts as items that satisfy the predetermined condition.

In addition, the system 700 may further include:

an item group name determining unit 707, configured to determine a name of the item group according to an identical part in the titles of all the items in the item group; and

an item group name storage unit 708, configured to store, in the item information database, the name of the item group and a target text describing the attribute value of the predetermined dimension in the title of each item, so that when the items in the same item group are presented, the name of the item group is presented, and different items are distinguished by the target texts.

Through the embodiments of the present application, goods having different attribute values in a predetermined dimension can be published as different items. Items that differ only in the attribute value of the predetermined dimension but are the same in other attributes can be grouped in an item group. Items in the same item group can be presented in the same information presentation position. This presentation method can reflect the richness of attribute values of goods more intuitively, and is more similar to the presentation mode of goods in a physical supermarket. This method can provide users an experience closer to shopping in a physical supermarket, promote purchase activities, and improve the effective utilization of information presented in webpages.

According to the descriptions of the foregoing embodiments, those skilled in the art may be clear that the present application can be implemented by means of software and a necessary general hardware platform. Based on such an understanding, the technical solutions in the present disclosure essentially, or the part contributing to the prior art may be implemented in the form of a software product. The computer software product may be stored in a storage medium, such as a ROM/RAM, a magnetic disk, or an optical disc, and includes several instructions for instructing a computer device (which may be a personal computer, a server, a network device, or the like) to perform the method described in the embodiments of the present disclosure or in some parts of the embodiments of the present disclosure.

The embodiments in the specification may be described in a progressive manner. For same or similar parts in the embodiments, reference may be made to each other. Each embodiment focuses on differences from other embodiments. For example, the system or system embodiment is similar to the method embodiment and therefore is described briefly, and for the relevant part, references may be made to the part of the description of the method embodiment(s). The system or system embodiment described above is merely exemplary, the units described as separate parts may or may not be physically separated, and the parts shown as units may or may not be physical units, and may be located in one position or may be distributed on multiple network units. Some or all of the modules may be selected according to actual needs to achieve the objectives of the solutions of the embodiments. Those of ordinary skill in the art can understand and implement the embodiments without creative efforts.

The method and apparatus for providing item information provided by the present disclosure are described in details above. Examples are used in the specification to elaborate the principle and implementation of the present disclosure. However, the descriptions of the foregoing embodiments are merely used to facilitate the understanding of the method and core idea of the present disclosure. Those of ordinary skill in the art can make modifications to the specific implementation and the application scope according to the idea of the present disclosure. Therefore, the content of the specification should not be construed as limiting the present disclosure.

Another aspect of the disclosure is directed to a non-transitory computer-readable storage medium storing instructions which, when executed, cause one or more processors to perform the methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for providing item information. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for providing item information, the method comprising:
receiving, by a server, a webpage access request;
providing, by the server, a target webpage based on the received webpage access request, wherein:
the target webpage comprises a target information presentation position presenting information about at least two items in the same item group, and
the item group comprises at least two similar items that differ in an attribute value of a predetermined dimension.

2. The method according to claim 1, wherein providing the target webpage comprises:
using an item information database to store at least one item group comprising at least two items that differ only in the attribute value of the predetermined dimension;
determining, upon receiving a request for presenting a target webpage, a target item group associated with the target information presentation position in the target webpage; and
generating webpage data of the target webpage according to information about items in the target item group.

3. The method according to claim 2, wherein:
the item information database further stores a name of the item group and a target text describing the attribute value of the predetermined dimension in a title of each item;
the name of the item group is determined according to an identical part in the titles of all the items in the group;
the target information presentation position comprises a name presentation bar and a plurality of information presentation sub-positions; and
the method further comprises:
determining the name of the target item group and the target text;
presenting the name of the target item group in the information presentation bar of the target information presentation position; and
presenting, in the information presentation sub-positions, representative pictures and titles of the items in the group, the title comprising only the target text.

4. The method according to claim 3, wherein:
the predetermined dimension comprises a perceptual attribute dimension other than a color attribute;
the item information database further stores a corresponding relationship among an identifier, a text, and a color of each item in the item group;
the text describes the perceptual attribute value in the title of the item;
the color expresses the perceptual attribute value; and
the method further comprises:
determining a target color that correspond to each item in the target item group; and
presenting, in the information presentation sub-positions, the target text in the corresponding target color.

5. The method according to claim 3, wherein the predetermined dimension comprises a package volume dimension.

6. A method for providing item information, the method comprising:
sending, by a client, a webpage access request to a server;
receiving webpage data from the server; and
presenting a target webpage based on the received webpage data, wherein:
the target webpage comprises a target information presentation position presenting information about at least two items in the same item group, and
at least two items in the item group differ in an attribute value of a predetermined dimension.

7. The method according to claim 6, wherein:
an item information database is stored in the server;
the database stores at least one item group comprising at least two items that satisfy a predetermined condition;
the at least two items differ only in the attribute value of the predetermined dimension; and
based on the request, the server determines a target item group associated with the target information presentation position in the target webpage, generates the webpage data of the target webpage according to information about items in the target item group, and returns the webpage data to the client.

8. A method for establishing an item information database, the method comprising:
publishing goods having different attribute values in a predetermined dimension as different front-end items;
determining, from the items, item groups each comprising at least two items that satisfy a predetermined condition, wherein the at least two items in the same item group differ in the attribute value of the predetermined dimension; and
storing identification information of the items in each item group to generate an item information database, causing the items in the same item group to be presented in the same information presentation position, when an item information list is presented in a webpage.

9. The method according to claim 8, wherein the predetermined dimension comprises a perceptual attribute dimension other than a color attribute.

10. The method according to claim 9, further comprising:
determining the perceptual attribute value of an item, and a target text describing the perceptual attribute value in a title of the item;
determining a target color that corresponds to the perceptual attribute value; and
storing, in the item information database, a corresponding relationship among an identifier, the target text, and the target color of the item, causing the target texts corresponding to the items of the perceptual attribute value other than the color attribute of different targets to be presented in different target colors, when the items in the same item group are presented.

11. The method according to claim 8, wherein the predetermined dimension comprises a package volume dimension.

12. The method according to claim 8, wherein determining, from the items, the item groups each comprising at least two items that satisfy a predetermined condition comprises:
extracting, from titles of the items, attribute value information of each item in the predetermined dimension; and
comparing remaining parts of the titles after the attribute value information in the predetermined dimension is removed to determine at least two items of which the remaining parts are the same as items as satisfying the predetermined condition.

13. The method according to claim 12, further comprising:
determining a name of the item group according to an identical part in the titles of all the items in the item group; and
storing, in the item information database, the name of the item group and a target text describing the attribute value of the predetermined dimension in the title of each item, causing the name of the item group to be presented and different items to be distinguished by the target texts, when the items in the same item group are presented.

14. An apparatus for providing item information, the apparatus comprising:
a request receiving unit configured to receive a webpage access request; and
a webpage data providing unit configured to provide a target webpage based on the webpage access request, wherein the target webpage comprises a target information presentation position presenting information about at least two items in the same item group, and the item group comprises at least two similar items that differ in an attribute value of a predetermined dimension.

15. The apparatus according to claim 14, wherein the webpage data providing unit comprises:
a database storage subunit configured to use an item information database to store at least one item group comprising at least two items that differ only in the attribute value of the predetermined dimension;
a target item group determining subunit configured to determine, upon receiving a request for presenting a target webpage, a target item group associated with the target information presentation position in the target webpage; and
a webpage data generating subunit configured to generate webpage data of the target webpage according to information about items in the target item group.

16. The apparatus according to claim 15, wherein:
the item information database further stores a name of the item group and a target text describing the attribute value of the predetermined dimension in a title of each item;
the name of the item group is determined according to an identical part in the titles of all the items in the group;
the target information presentation position comprises a name presentation bar and a plurality of information presentation sub-positions; and
the webpage data providing unit further comprises:
an item group name determining subunit configured to determine the name of the target item group and the target text that corresponds to each item;
a group name presentation subunit configured to present the name of the target item group in the information presentation bar of the target information presentation position; and
a title presentation subunit configured to present, in the information presentation sub-positions, representative pictures and titles of the items in the group, the title comprising the target text.

17. The apparatus according to claim 15, wherein:
the predetermined dimension comprises a perceptual attribute dimension other than a color attribute;
the item information database further stores a corresponding relationship among an identifier, a text, and a color of each item in the item group, the text describing the perceptual attribute value in the title of the item, and the color expressing the perceptual attribute value; and
the webpage data providing unit further comprises:
a color information determining subunit configured to determine a target text and a target color that correspond to each item in the target item group, and
a color presentation subunit configured to present the target texts in the corresponding target colors in the information presentation sub-positions.

18. The apparatus according to claim 15, wherein the predetermined dimension comprises a package volume dimension.

19. An apparatus for providing item information, the apparatus comprising:
a request forwarding unit configured to send a webpage access request to a server;
a webpage data receiving unit configured to receive webpage data from the server, and present a target webpage based on the received webpage data, wherein:
the target webpage comprises a target information presentation position presenting information about at least two items in the same item group, and
at least two items in the item group differ in an attribute value of a predetermined dimension.

20. The apparatus according to claim 19, wherein:
an item information database is stored in the server;
the database stores at least one item group comprising at least two items that satisfy a predetermined condition;
the at least two items differ only in the attribute value of the predetermined dimension; and
based on the request, the server is configured to determine a target item group associated with the target information presentation position in the target webpage, generates the webpage data of the target webpage according to information about items in the target item group, and returns the webpage data to the client.
